(19) United States
(12) Patent Application Publication
(10) Pub. No.: US 2015/0039451 A1
(43) Pub. Date: Feb. 5, 2015

(54) Biometrics for Rapid and Enhanced Service and Hospitality and Quantification Thereof

(71) Applicant: Richard Paul Bonfiglio, Murrysville, PA (US)

(72) Inventor: Richard Paul Bonfiglio, Murrysville, PA (US)

(21) Appl. No.: 14/252,941

(22) Filed: Apr. 15, 2014

Related U.S. Application Data
(63) Continuation-in-part of application No. 13/959,162, filed on Aug. 5, 2013, now abandoned.

(51) Int. Cl. G06Q 50/12; G06K 9/00

(52) U.S. Cl. CPC G06Q 50/12; G06K 9/00006; G06K 9/00221; G06K 9/00597
USPC 705/15

(57) ABSTRACT

The present invention provides a computer-implemented system and method for enhanced service and hospitality by a facility, such as a restaurant, using biometric identifiers, such as facial recognition, fingerprint identification, palm print identification, iris recognition, retina recognition and voice recognition, and a computer-implemented means for quantifying the rapidity of service to enrolled customers in the program compared to customers not enrolled in the program. Customers enroll in the program and provide specific biometric identifiers as well their one or more preferences related to one or more foods, drinks and/or services provided by the facility.

### CROSS REFERENCE TO RELATED APPLICATIONS

This application is a continuation-in-part application of application Ser. No. 13/959,162, filed Aug. 5, 2013, which is incorporated herein by reference in its entirety.

### FIELD OF THE INVENTION

The present invention relates to service and hospitality facilities and, more particularly, to computer-implemented systems and methods using biometrics to provide rapid and enhanced service and hospitality to customers enrolled in an enhanced service and hospitality program provided by the facilities, and computer-implemented means for quantifying the rapidity of service of enrolled customers compared to non-enrolled customers.

### BACKGROUND OF THE INVENTION

The hospitality industry is a broad category of fields within the service industry which includes lodging, restaurants, event planning, theme parks, transportation, cruise lines, and additional fields within the tourism industry.

In today's fast-paced and overcrowded society, customers of service and hospitality facilities often are burdened with long lines and wait times to procure a desired service, such as buying a morning coffee before work, or checking into a hotel, oftentimes after spending hours traveling to their destination. This not only results in much wasted time that could be spent more productively and enjoyably, but also may cause unneeded stress and frustration.

Even when there is no wait time for a particular service, such as when one has a reservation at a fine restaurant, some of the time spent upon entering the restaurant may be used to decide which table the diner would prefer, as well as time spent to inquire whether the diner would like a cocktail, wine, or sparkling or still water. In addition, some patrons may order the same appetizer, salad, soup, dessert, coffee, espresso and/or after-dinner drink each time they eat at a particular restaurant. In such cases, it would be advantageous to not be interrupted at the beginning and/or during the meal by a server taking one's dinner order, or after a meal by the server bringing a check and processing payment.

Hospitality and service providers are aware of above-described burdens which may be placed on their customers, and thus are constantly looking to improve and maximize efficiencies and effectiveness of their services.

A strong need exists, therefore, to provide rapid, efficient and enhanced service and hospitality to customers of service-related facilities, as well as a way to quantitate the rapidity of those services so that hospitality and service providers have a reliable and accurate way to gauge the efficiency and effectiveness of their services.

### SUMMARY OF THE INVENTION

The present invention fulfills this need by providing a computer-implemented system and method using biometrics for enhanced service and hospitality by a facility to a customer having one or more preferences related to one or more foods, drinks and/or services provided by the facility; and computer-implemented means for quantifying the rapidity of service to enrolled customers in the program compared to customers not enrolled in the program.

In an aspect of the invention, there is provided a computer-implemented system using biometrics for providing rapid order lead time for a customer enrolled in an enhanced service and hospitality program offered by a facility, compared to order lead time for a customer not enrolled in the program. The computer-implemented system comprises execution of a biometric identification software program to identify biometric identifiers of a customer by one or more computing devices when the customer enters the facility, the biometric identifiers of the customer acquired by a biometric image acquisition sensor, the acquired biometric identifiers relayed to the one or more computing devices which determines whether the customer entering the facility is an enrolled customer in a service and hospitality program offered by the facility. When the one or more computing devices determines that the customer entering the facility is an enrolled customer, data for the enrolled customer is displayed on a display screen of the one or more computing devices, the data comprising a customer identification number assigned to the enrolled customer, name, address, payment information, photograph, and one or more preferences of the customer for one or more foods and/or drinks sold by the facility. One or more service providers of the facility views the data of the enrolled customer on the display screen and inputs time of viewing by clicking a “begin order lead time” button on the display screen. Clicking the begin order lead time button begins order lead time for an order for one or more foods and/or drinks preferred by the enrolled customer, the one or more service providers placing the order by relaying the order to one or more order preparers via the one or more computing devices, the one or more order preparers preparing the order and, when the order is completed, clicking an end order lead time button on the display screen. Clicking the end order lead time button ends the order lead time for the order of the enrolled customer, and a service provider delivers the prepared order to a service and hospitality area of the facility for pick-up by the enrolled customer. The system then comprises calculation by the one or more computing devices of the order lead time of the enrolled customer, wherein the order lead time is equal to the difference between the begin order lead time and the end order lead time. The order lead time is automatically inputted by the one or more computing devices into a database containing order lead times for all enrolled customers. The one or more computing devices then calculates the average order lead time for all enrolled customers contained in the database.

The system also comprises calculation by the one or more computing devices of the order lead time for an order placed by a customer not enrolled in the enhanced service and hospitality program after the begin order lead time and the end order lead time for the order of the non-enrolled customer has been relayed to a database of the one or more computing devices containing order lead times for all non-enrolled customers. The begin order lead time for a non-enrolled customer is the time when the non-enrolled customer takes a number from a number dispenser device showing a customer order number and the time when the number is taken, the dispenser device relaying the customer order number and the begin order lead time to one or more computing devices, the customer order number and the begin order lead time stored in a database of the one or more computing devices. The end order lead time for a non-enrolled customer is the time when the order is completed by an order preparer, the order preparer clicking an end order button for the non-enrolled customer on a display screen of the one or more computing devices. The system then comprises calculation by the one or more computing devices of the order lead time of the non-enrolled customer, wherein the order lead time is equal to the difference between the begin order lead time and the end order lead time. The order lead time is automatically inputted by the one or more computing devices into a database containing order lead times for all non-enrolled customers. The one or more computing devices then calculates the average order lead time for all non-enrolled customers contained in the database.

In another aspect of the invention, there is provided a computer-implemented method using biometrics for providing rapid order lead time for a customer enrolled in an enhanced service and hospitality program offered by a facility, compared to order lead time for a customer not enrolled in the program. The method comprises storing biometric identifiers provided by a customer enrolled in an enhanced service and hospitality program offered by a facility in a template set in a database contained in database management software, the database management software operated by at least one microprocessor, the at least one microprocessor controlling one or more computing devices; storing data of the enrolled customer in the database, the data comprising a customer identification number, name, address, payment information, a photograph, and one or more preferences of the customer for one or more foods and/or drinks sold by the facility; executing a biometric identification software program to identify biometric identifiers of a customer by the one or more computing devices when the customer enters the facility, said biometric identifiers of the customer acquired by an image acquisition sensor, said acquired biometric identifiers relayed to the one or more computing devices which determines whether the customer entering the facility is an enrolled customer in the service and hospitality program offered by the facility; viewing the data of the customer on the display screen by a service provider when the one or more computing devices determines that the customer is an enrolled customer, said time of the viewing beginning order lead time for an order of one or more foods and/or drinks of the customer; inputting time of viewing by the service provider by clicking a begin order lead time button on the display screen, wherein clicking the begin order lead time button begins order lead time for an order of the one or more foods and/or drinks preferred by the enrolled customer, placing the order by one of the one or more service providers by relaying the order to one or more order preparers via one of the one or more computing devices; preparing the order by the one or more order preparers; clicking an end order lead time button on the display screen when the order is completed, wherein clicking the end order button ends the order lead time for the order of the enrolled customer; delivering the order after it is prepared to a service and hospitality area of the restaurant for pick-up by the enrolled customer; calculating by the one or more computing devices the order lead time of the enrolled customer, wherein said order lead time is equal to the difference between the begin order lead time and the end order time, wherein the order lead time is automatically inputted into a database by the one or more computing devices containing order lead times of all enrolled customers, the one or more computing devices calculating the average order lead time for all enrolled customers contained in the database; calculating by the one or more computing devices the order lead time for a customer not enrolled in the enhanced service and hospitality program after the begin order lead time and the end order lead time for the order by the non-enrolled customer has been relayed to a database of the one or more computing devices containing order lead times for all non-enrolled customers, the one or more computing devices calculating the average order lead time for all non-enrolled customers; and calculating by the one or more computing devices an average order lead time of enrolled customers that is between five to ten times faster than the average order lead time of non-enrolled customers.

The one or more computing devices which may be used in the systems and methods of the invention includes, without limitation, desktop computers, laptop computers, tablets, computer notebooks, smartphones or any other computing device having a display screen.

In accordance with the invention, the display screen may be a video screen or any other computer screen capable of displaying text and photographs.

In accordance with the invention, a facility offering the enhanced service and hospitality program will have an enhanced service and hospitality area designated solely for enrolled customers, to which the enrolled customers will go to in order to pick up their one or preferences related to services offered by the facility.

Facilities which may provide the enhanced service and hospitality program of the invention include, without limitation, goods and/or service-related facilities, such as retail food and/or drink establishments, restaurants, hotels, motels, inns, lodges, bed and breakfasts, airports, cruise lines, amusement parks, or any other service-related facilities providing recreational, travel and/or tourism-related services.

### BRIEF DESCRIPTION OF THE DRAWINGS

A fuller understanding of the invention can be gained from the following description when read in conjunction with the accompanying figures, where like reference numerals refer to identical or functionally similar elements throughout the separate views. The figures illustrate some, but not the only and exclusive, examples of embodiments of the invention and, as such, the embodiments and figures disclosed herein are to be considered illustrative rather than limiting. In the drawings:

FIG. 1 is a block diagram showing the enrollment process in the enhanced service and hospitality program, in accordance with the invention;

FIG. 2 is a flow chart showing the steps for quantifying the average order lead time for enrolled customers and for non-enrolled customers, in accordance with the invention;

FIG. 3 is a flow chart using facial recognition software to identify enrolled customers in the enhanced service and hospitality program, in accordance with the invention;

FIG. 4 is a flow chart using fingerprint identification software to identify enrolled customers in the enhanced service and hospitality program, in accordance with the invention;

FIG. 5 is a flow chart using palm print identification software to identify enrolled customers in the enhanced service and hospitality program, in accordance with the invention;

FIG. 6 is a flow chart using iris recognition software to identify enrolled customers in the enhanced service and hospitality program, in accordance with the invention;

FIG. 7 is a flow chart using retina recognition software to identify enrolled customers in the enhanced service and hospitality program, in accordance with the invention;

FIG. 8 is a flow chart using voice recognition software to identify enrolled customers in the enhanced service and hospitality program, in accordance with the invention;

FIG. 9 is an exemplary graphical interface for online enrollment in the enhanced service and hospitality program provided by a coffee retail facility, in accordance with the invention;

FIG. 10 is an exemplary graphical interface for online enrollment in the enhanced service and hospitality program provided by a fine dining restaurant, in accordance with the invention;

FIG. 11 is an exemplary graphical interface for online enrollment in the enhanced service and hospitality program provided by a hotel, in accordance with the invention; and

FIG. 12 is an illustration of an embodiment of the systems and methods of the invention in operation.

### DETAILED DESCRIPTION OF THE INVENTION

The systems and methods of the invention are accomplished with the use of a biometric image acquisition sensor which captures certain biometric identifiers of a customer, one or more computing devices in communication with the sensor, biometric identification or recognition software, and database software running on the one or more computing devices. Upon identification of a customer enrolled in the enhanced service and hospitality program, referred to herein as a enrolled customer, database storage of a customer identification number assigned to the enrolled customer, a photograph, name, address, payment information, and one or more preferences for one or more foods and/or drinks offered by the restaurant, are retrieved and displayed on a display screen of the one or more computing devices so that the one or more preferences of the enrolled customer may be processed by a service provider of the facility.

As used herein the phrase “biometric identifiers” is interchangeable with the phrase “biometric characteristics,” and is defined as the science and technology of measuring and analyzing human physiological characteristics.

As used herein, the phrase “order lead time” which phrase is interchangeable with the phrase “actual order lead time (OLT_{actual}),” is defined as the amount of time elapsed from the time an enrolled customer's order is viewed on a display screen of a computing device or, in the case of a non-enrolled customer, the time that the non-enrolled customer takes a number from a “take-a-number” device at an order area of the restaurant, to the time when the order for the enrolled customer and the non-enrolled customer is entered into one or more computing devices as being completed.

As used herein, the phrase “average order lead time” for enrolled customers is defined as the sum of all order lead times of enrolled customers contained in a database of one or more computing devices divided by the number of enrolled customers.

As used herein, the phrase “average order lead time” for non-enrolled customers is defined as the sum of all order lead times of non-enrolled customers contained in a database of one or more computing devices divided by the number of non-enrolled customers.

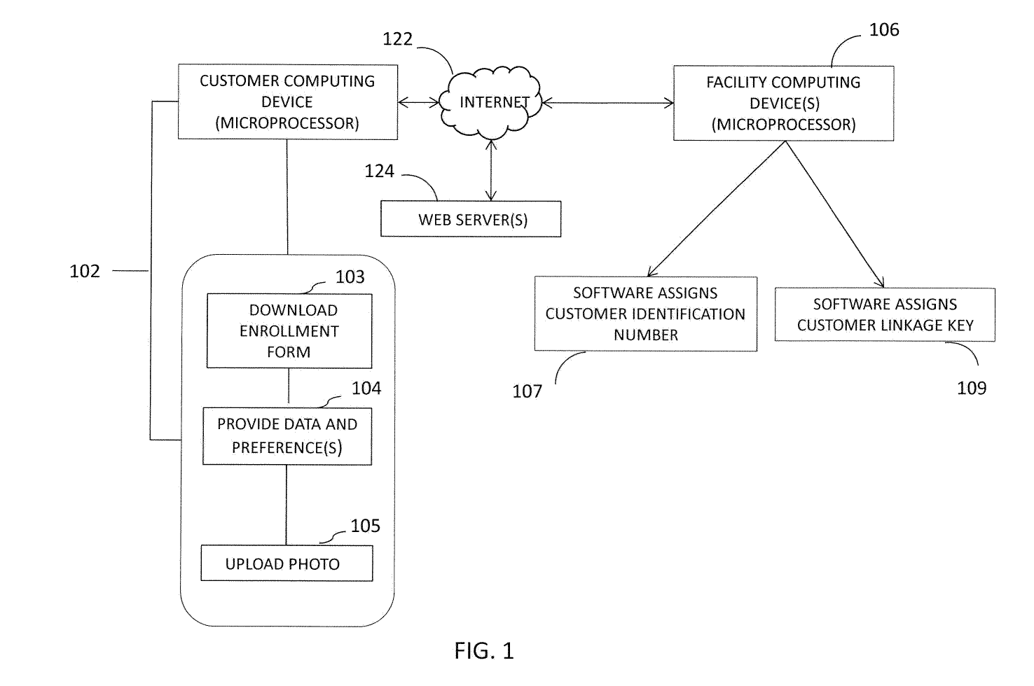

The systems and methods of the enhanced service and hospitality program are further described with respect to the following figures. As shown in FIG. 1, the invention includes one or more web servers 124 coupled to the internet 122, in which a customer of a facility wanting to enroll in the enhanced service and hospitality program offered by the facility connects to the website of the facility via a computing device 102, such as a desktop or laptop computer, a tablet, a notebook, a smartphone or any other network computing device. The customer downloads and fills out an enrollment form 103 (the main contents of which are described in detail below), which contains personal profile questions, other required information, such as, without limitation, security and payment (i.e., credit card) information, and one or more preferences 104 related to goods and/or services offered by the facility, such as foods and/or drinks sold by the facility. In addition, the customer uploads a photograph 105 of themselves. In the case where the facility uses facial recognition software to identify enrolled customers, the photograph can be uploaded using facial recognition software running on the computing device 102 of the customer. The completed enrollment form and photograph is sent via the internet 122 and the one or more web servers 124 to one or more computing devices of the facility 106, which retrieves the information and photograph sent by the customer.

The one or more computing devices of the facility 106 receives the information sent from the customer's computing device 102. When the customer is accepted into the program, (the customer now referred to as a “enrolled customer”), the one or more computing devices of the facility 106 runs database software which assigns a customer identification number 107 and a customer linkage key 109 to the enrolled customer, and stores the photograph of the customer 105, as well as the data and the one or more preferences 104 of the customer related to services provided by the facility in the database of the one or more computing devices 106.

In accordance with the systems and methods of the invention, one or more computing devices may be used in the enhanced service and hospitality program of a given facility depending on the needs of the facility. The invention contemplates that the number of computing devices a facility uses to implement the enhanced service and hospitality program will be determined by the number of enrolled customers enrolled in the program, as well as the traffic of enrolled customers frequenting the facility on a regular basis. It will be appreciated that a facility having a large number of enrolled customers will need more computing devices to accommodate those customers compared to a facility with a small number of enrolled customers and/or faster traffic of those customers on a regular basis. When two or more computers are used by a facility, each of the two or more computers is connected with each of the other computers as part of a local area network (LAN) of the facility.

Suitable computing devices used by a facility to implement the enhanced service and hospitality program of the invention include, without limitation, desktop computers, laptop computers, tablets, computer notebooks, smartphones or any other computing devices having a display screen and adequate storage capacity. In accordance with the invention, it is contemplated that facilities offering the enhanced service and hospitality program will have a sufficient number of additional computing devices to accommodate the number of enrolled customers in the program.

In accordance with the invention, biometric identifiers, which include, without limitation, fingerprints, palm prints, iris features, retina features, and voice and speech patterns, will need to be obtained in person from a customer at the facility offering the enhanced service and hospitality program, whereas facial identifiers can be provided remotely by uploading a close-up photograph of the customer.

Upon enrollment, the specific biometric identifiers, one or more preferences of foods and/or drinks, name, address, payment information, photograph, and customer identification number all are stored in the database of the one or more computing devices. Using the specific biometric identification or recognition software contained in the one or more computing devices of the facility, a biometric identification profile of the enrolled customer photograph is created, which is stored in a template set of the database of the one or more computing devices.

The customer linkage key assigned to the enrolled customer links together the biometric identifiers, name, address, photograph, payment information, and the one or more preferences of the enrolled customer. When the enrolled customer is identified by specific biometric identification or recognition software, which identification occurs when one or more biometric identifiers captured by an image acquisition sensor device is matched with one or more biometric identifiers stored in a template set of the database, the customer linkage key retrieves and displays on the display screen the name, photograph, personal profile, payment information, and the one or more food and/or drink preferences of the enrolled customer.

Those skilled in the art will appreciate that the communication network comprising a computing device of a customer, one or more computing devices of a facility, the internet, and one or more web servers, as illustrated and described herein, is somewhat simplified, as those skilled in the art will be familiar with and have knowledge of how such computing devices communicate with one another (i.e., uploading, downloading, sending, receiving and retrieving information via the internet and web server(s), and running applicable software).

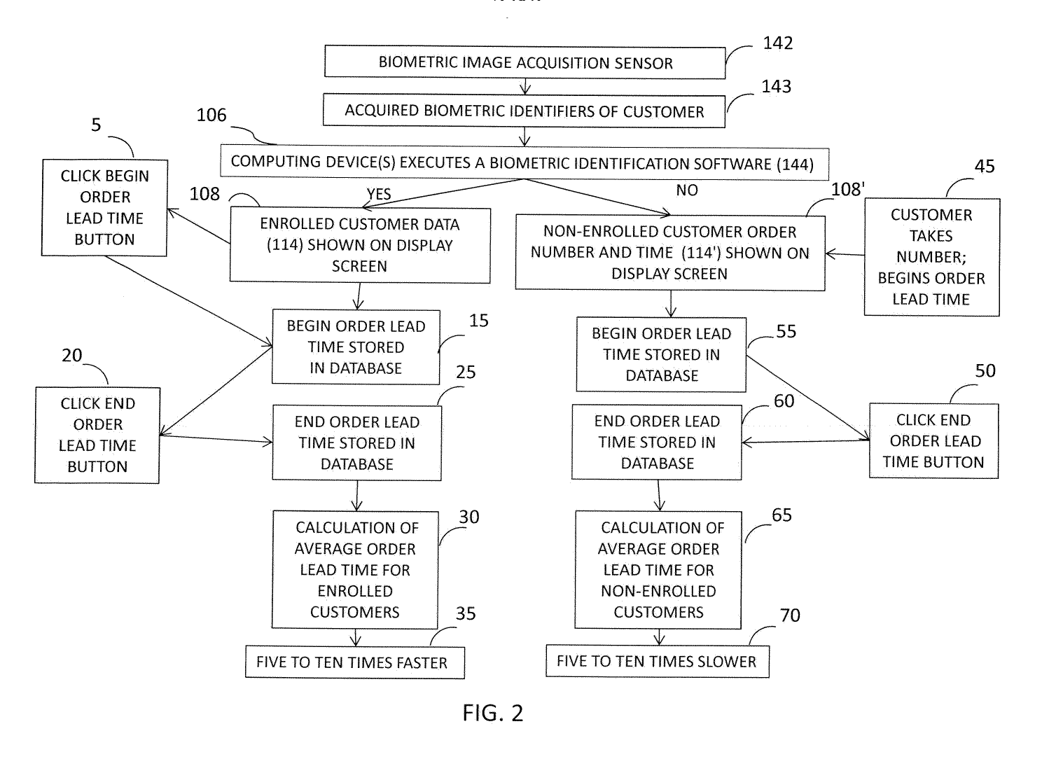

FIG. 2 is a flow chart of the computer-implemented system using biometrics for providing rapid order lead time for a customer enrolled in the enhanced service and hospitality program offered by a facility in accordance with the invention. When a customer enters a facility, the enrolled customer actively interacts with a biometric image acquisition sensor 142 in order to capture, i.e., acquire, specific biometric identifiers 143 of the enrolled customer by the image acquisition sensor 142. The type of interaction depends upon the specific biometric identifiers used by the facility to identify enrolled customers. In the case of facial recognition, a faceprint of all customers entering the facility is passively captured by the image acquisition sensor, i.e., camera. The acquired biometric identifiers 143 then are relayed to one or more computing devices 106, which executes a specific biometric identification software program 144 to determine whether the customer entering the facility is enrolled in the service and hospitality program offered by the facility.

When the one or more computing devices 106 determines that the customer entering the restaurant is an enrolled customer, data 114 for the enrolled customer is displayed on a display screen 108 of the one or more computing devices 106, the data 114 comprising a customer identification number assigned to the enrolled customer, name, address, payment information, photograph of the customer, and one or more preferences of the customer for one or more foods and/or drinks sold by the facility. One or more service providers of the facility views the data 114 of the enrolled customer on the display screen and inputs time of viewing by clicking a begin order button 5 on the display screen 114. Clicking the begin order button 5 begins order lead time for an order of one or more foods and/or drinks preferred by the enrolled customer, which begin order lead time is stored in the database 15. The one or more service providers places the order by relaying the order to one or more order preparers via the one or more computing devices 106, the one or more order preparers prepares the order and, when the order is completed, clicks an end order lead time button 20 on the display screen. Clicking the end order button 20 ends the order lead time for the order of the enrolled customer, which end order lead time is entered into the database 25. The one or more service providers deliver the prepared order to a service and hospitality area of the facility for pick-up by the enrolled customer. The order lead time for that enrolled customer is calculated by the one or more computing devices, which is equal to the difference between the begin order lead time and the end order time. The order lead time is inputted into a database containing order lead times of all enrolled customers. The one or more computing devices then calculates the average order lead time for all enrolled customers 65.

When a non-enrolled customer enters the facility, the non-enrolled customer walks to a take-a-number device, which device is well known in the art, and takes a customer order number, which begins order lead time 45 for the non-enrolled customer, which begin order lead time is stored in a database 55. When the non-enrolled customer gets to the order area and their turn comes to place their order, a service provider takes the order of the non-enrolled customer and enters it into the one or more computing devices which shows the customer order number and the begin order lead time 114′ for that customer on the display screen 108′. The service provider places the order by relaying the order to one or more order preparers via the one or more computing devices, the one or more order preparers prepares the order and, when the order is completed, clicks an end order lead time button 50 on the display screen. Clicking the end order button 50 ends the order lead time for the order of the non-enrolled customer, which end order lead time is entered into the database 60. A service provider delivers the prepared order to a conventional pick-up area for pick-up by the non-enrolled customer. The order lead time for the non-enrolled customer is calculated by the one or more computing devices, which is equal to the difference between the begin order lead time and the end order time. The order lead time is relayed to a database containing order lead times of all non-enrolled customers. The one or more computing devices then calculates the average order lead time for all non-enrolled customers 65 contained in the database. The one or more computing devices continuously and automatically updates the average order lead times for enrolled customers 30 and for non-enrolled customers 65 as begin order lead times and end order lead times for the customers are inputted into their respective databases. The average order lead time for enrolled customers 30 is shown to be five to ten times faster 35 than for non-enrolled customers 65, i.e., the average order lead time for non-enrolled customers 65 is shown to be five to ten times slower 70 than the average order lead time for enrolled customers 30.

In accordance with the invention, a service provider of the facility viewing an order on a computer is able to easily distinguish between orders for non-enrolled customers and orders for enrolled customers by seeing the type of information displayed for a particular customer: orders for enrolled customers will show the customer identification number, other data and the one or more preferences of one or more foods and/or drinks, whereas orders for non-enrolled customers will show only the order for one or more foods and/or drinks and a customer order number. In accordance with the invention, it is contemplated that whether the order is for an enrolled customer or a non-enrolled customer, there will be no difference in the efficiency and time spent to prepare the order by an order preparer.

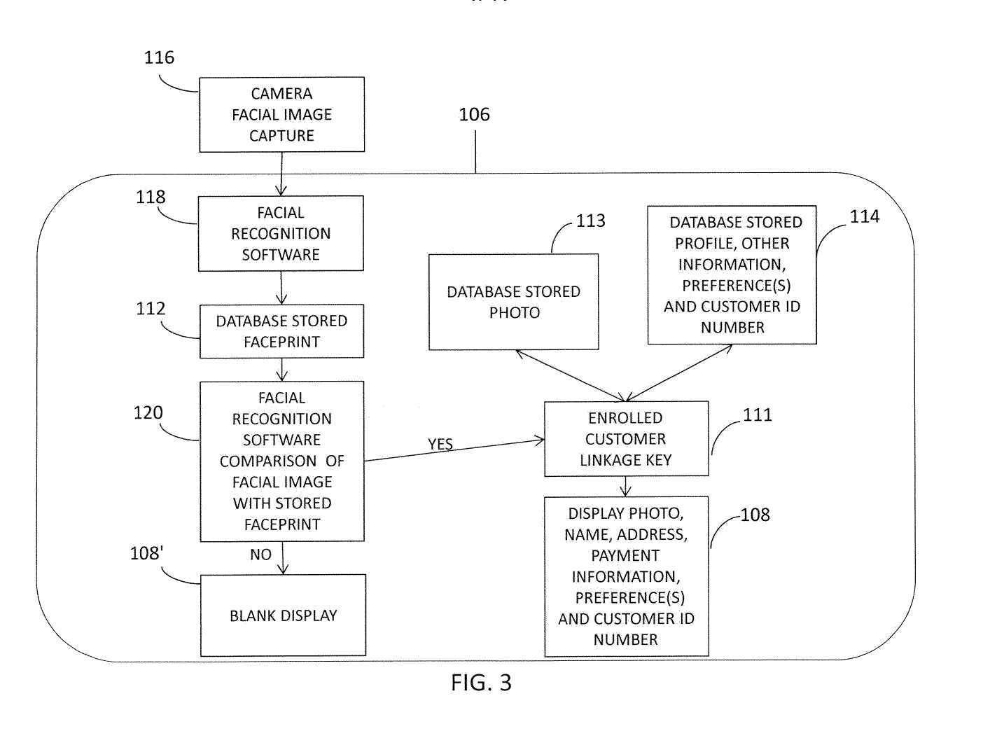

FIGS. 3-8 are flow charts illustrating the general scheme for specific biometrics indicators in accordance with the invention.

FIG. 3 shows the use of facial recognition for identifying an enrolled customer. A facial image of a customer is captured by a camera 116, and facial recognition software 118 compares the camera-captured facial image 116 with database-stored faceprints 112 to determine whether there is a match 120. When a match is found between the camera-captured facial image 116 and a stored faceprint 112 of a enrolled customer, this prompts the linkage key 111 assigned to the identified enrolled customer to display the stored data 114, i.e., customer identification number, name, address, photograph, payment information, and the one or more preferences of one or more foods and/or drinks, on a display screen 108 of the one or more computing devices 106. When the facial recognition software 118 does not find a match between the camera-captured facial image 116 and a stored faceprint 112 after running a comparison 120, the display screen remains blank 108′.

Facial recognition computer-implemented systems extract certain features from face images and then perform face matching using these features via facial recognition software. A face does not have as many uniquely measurable features as fingerprints and irises, so facial recognition reliability is slightly lower than these other biometric recognition methods.

Faceprints created by facial recognition software are well known by those skilled in the art and include, without limitation, identifying “nodal points” of a face, such as the distance between the eyes, the width of the nose, the shape of the cheekbones, the length of the jaw line and other facial feature dimensions. The nodal points are measured and a numeric code, i.e., “faceprint” for the enrolled customer is stored in database.

In accordance with the invention, a camera 116, such as a digital camera or video device, is positioned at or near the entrance of a facility providing the enhanced service and hospitality program. The invention contemplates that the camera 116 is positioned at a location best able to capture full-face facial images of customers as they enter the facility.

In an embodiment, the camera 116 captures real time video digital images. The camera 116 and images communicated therefrom are paired to the one or more computing devices 106 of the facility, either wirelessly via, for example, radio frequency, and accomplished with a unique identifier such as an electronic or actual serial number, or by wire. Communication between cameras, such as digital video cameras, and computing devices are well known by those skilled in the art and are encompassed in the systems and methods of the invention.

Any suitable camera may be used in the invention, such as, without limitation, a digital camera or a video device. In accordance with the invention, a facility places the camera at or near the entrance to the facility to capture facial images of customers as they approach near and/or enter the facility.

The invention contemplates that a facility offering the enhanced service and hospitality program using facial recognition as the biometric identifier will request a photograph from an enrolled customer which depicts their face as the enrolled customer expects to look each time they approach and/or enter the facility. This consistency of facial image is to ensure that the facial image and a stored faceprint of the enrolled customer are similar enough so that the facial recognition software is capable of matching the facial image to the faceprint of the enrolled customer.

The invention also contemplates that an enrolled customer will position their face in front of the camera of the facility so that their facial image will be adequately captured by the camera.

The invention further contemplates that when a enrolled customer wishes to have one or more different items and/or one or more different preferences, rather than their usual one or more preferred items and/or one or more preferences, when visiting a particular facility, the enrolled customer may opt out of the enhanced service and hospitality program by doing one or more of the following actions to prevent adequate comparison between their facial image and their faceprint when facial recognition software is used by the facility: (1) face slightly away from the camera at the entrance of the facility so that an adequate facial image is not captured by the camera; (2) place a hand or other item over a portion of their face, such as their forehead, nose, mouth or chin; (3) wear or not wear glasses if in their photograph provided to the facility no glasses or glasses, respectively, were worn; (3) make a facial expression that is different from the photograph they provided to the facility; (4) and/or by any other action that changes or hides their facial image adequately enough so that no matches between their facial image and stored faceprints can be made by the facial recognition software. The invention contemplates that when a enrolled customer chooses to opt out of the program provided by a facility, which opting out may occur at little as one time or a plurality of times, the enrolled customer then would proceed to a general service area, rather than the designated enhanced service and hospitality area, to be serviced conventionally, i.e., by waiting on line if necessary, by communicating their changed preferences to a service provider, and by proffering payment for the service.

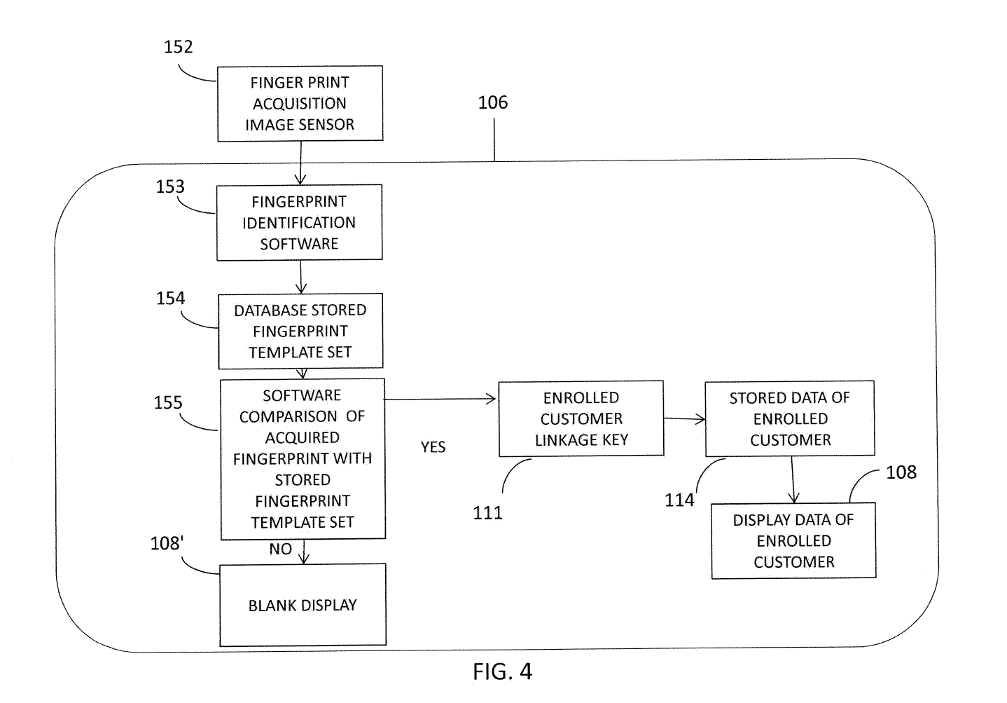

FIG. 4 shows the use of fingerprint identification for identifying an enrolled customer. A fingerprint impression of an enrolled customer is acquired by a fingerprint acquisition image sensor 152. Fingerprint identification software 153 compares the fingerprint impressions with a template set of fingerprints stored in a database 154 to determine whether there is a match 155. When a match is found between the acquired fingerprint impression and stored fingerprint impression contained in the template set, this prompts the linkage key 111 assigned to the identified enrolled customer to display the stored data 114, i.e., customer identification number, name, address, photograph, payment information, and the one or more preferences of one or more foods and/or drinks, on a display screen 108 of the one or more computing devices 106. When the fingerprint identification software 153 does not find a match between the fingerprint impressions with a template set of fingerprints stored in a database 154 after running a comparison 155, the display screen remains blank 108′.

Human fingerprints are unique to each person, including identical twins, and can be regarded as a sort of signature, certifying a person's identity. Because no two fingerprints are identical, the process of identifying a fingerprint involves comparing the ridges and impressions on one fingerprint to those of another fingerprint.

For example, automated fingerprint identification systems (AFIS) involve capturing the likeness of a fingerprint through use of a fingerprint scanner which takes a digital picture of a live fingerprint. Another fingerprint identification system extracts features of minutiae points, i.e., points where tiny ridges and capillary lines in a fingerprint have branches or endpoints, from the fingerprint image, and matches these sets of very specific fingerprint features with a database of fingerprint images. The extraction and comparison of minutiae points requires sophisticated algorithms for reliable processing of fingerprint images.

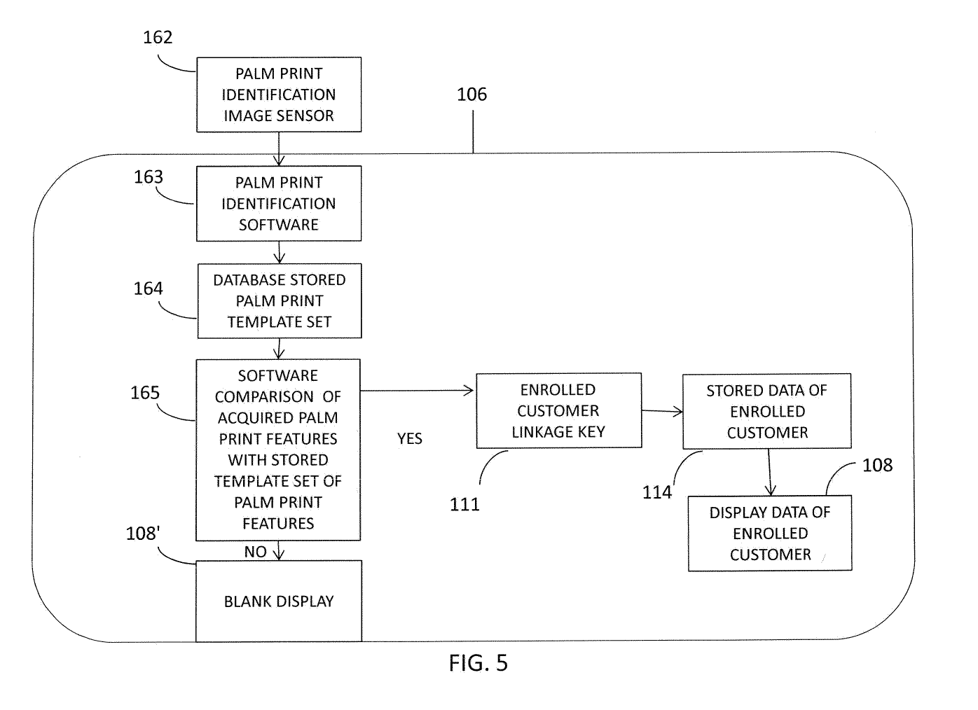

FIG. 5 shows the use of palm print identification for identifying an enrolled customer. A palm print impression of an enrolled customer is acquired by a palm print acquisition image sensor 162. Palm print identification software 163 compares palm print impressions with a template set of palm prints stored in a database 164 to determine whether there is a match 165. When a match is found between the palm print impression and stored palm print impressions contained in the template set, this prompts the linkage key 111 assigned to the identified enrolled customer to display the stored data 114, i.e., customer identification number, name, address, photograph, payment information, and the one or more preferences of one or more foods and/or drinks, on a display screen 108 of the one or more computing devices 106. When the palm print identification software 163 does not find a match between the palm print impression with a template set of palm prints stored in a database 164 after running a comparison 165, the display screen remains blank 108′.

Palm print impressions involve capturing an impression of vein patterns in the palm, which patterns are unique to each individual, even identical twins. Palm vein identification involves having a person place their hand on a hand guide, i.e., plastic casing, of a scanning device. The person's vein pattern is captured by lighting the hand with near-infrared light. Veins contain deoxidized hemoglobin, an iron-containing pigment which absorbs the near-infrared light and reduces the reflection rate causing the veins to appear as a black pattern on a display screen. Palm vein authentication has a high level of authentication accuracy due to the complexity of vein patterns of the palm.

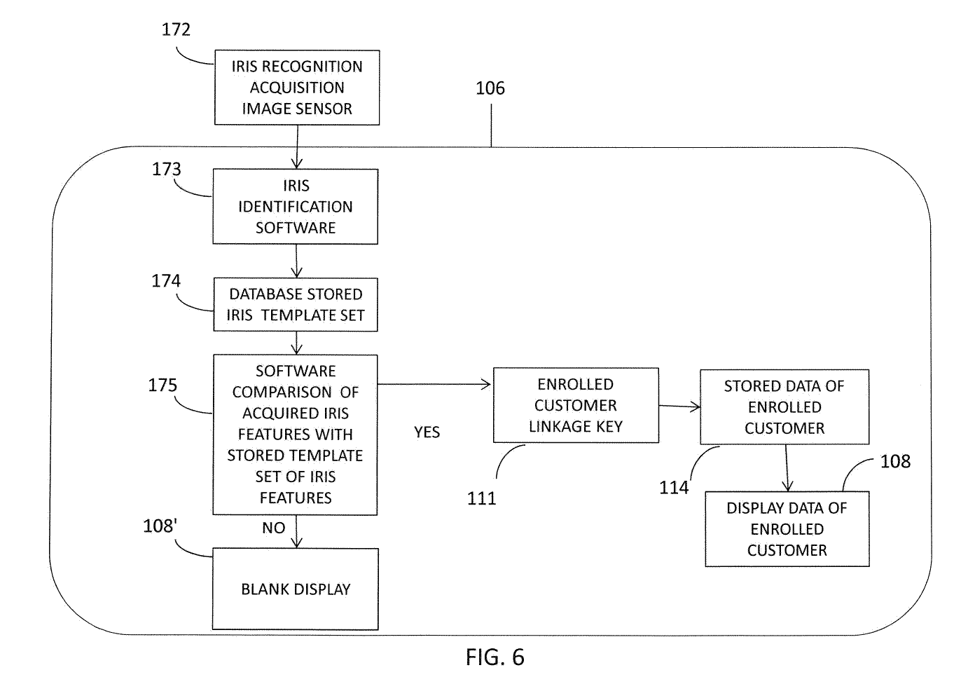

FIG. 6 shows the use of iris identification for identifying an enrolled customer. An iris image of an enrolled customer is acquired by an iris image acquisition sensor 172. Iris image identification software 173 compares the acquired iris image with a template set of iris images stored in a database 174 to determine whether there is a match 175. When a match is found between the acquired iris image and stored iris images contained in the template set, this prompts the linkage key 111 assigned to the identified enrolled customer to display the stored data 114, i.e., customer identification number, name, address, photograph, payment information, and the one or more preferences of one or more foods and/or drinks, on a display screen 108 of the one or more computing devices 106. When the iris image identification software 173 does not find a match between the acquired iris image with the template set of iris images stored in the database 174 after running a comparison 175, the display screen remains blank 108′.

Iris recognition is an automated method of biometric identification that uses mathematical pattern-recognition techniques on video images of the irises of an individual's eyes, which complex random patterns are unique and can be seen from some distance. Video images of the irises are captured using an iris scanning device.

The iris is the annular, colored region of the eye bounded by the dark pupil in the center and the sclera, i.e., the white of the eye on either side. The complex iris texture carries very distinctive information which is used for identification. The recognition system includes iris segmentation, enrollment and matching, using complex digital image processing algorithms. The algorithms are able to detect individual irises under various conditions, such as visual noise, lighting reflections, obstructions in eye images, gazing-away eyes and eyes with narrowed eyelids.

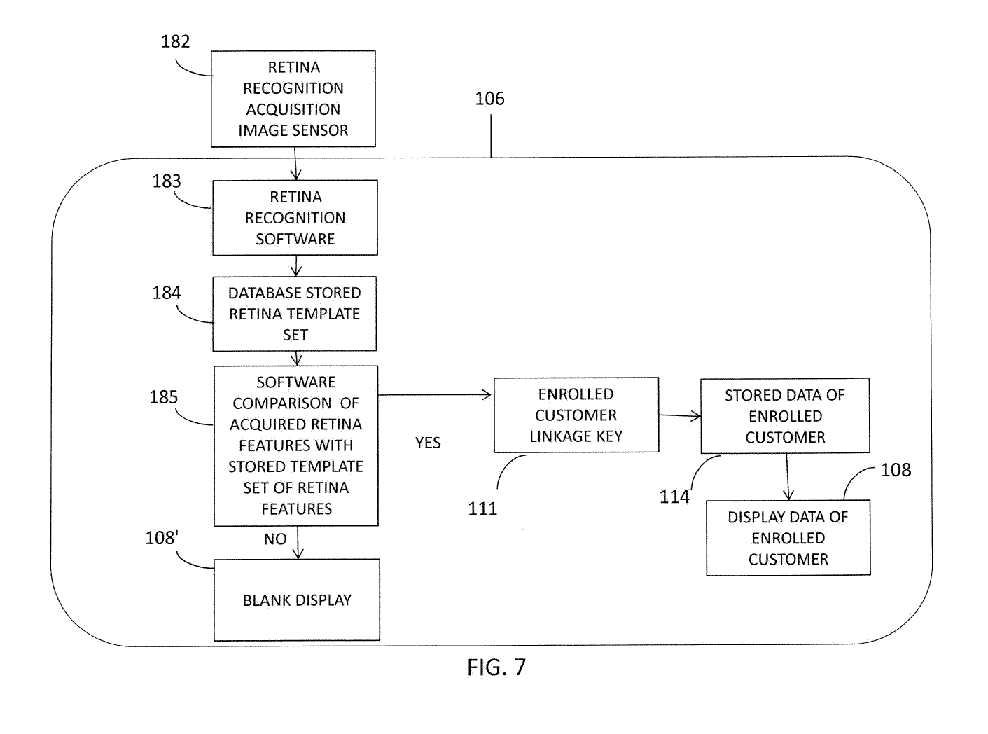

FIG. 7 shows the use of retina image identification for identifying an enrolled customer. A retina image of an enrolled customer is acquired by retina image acquisition sensor 182. Retina image identification software 183 compares the acquired retina image with a template set of retina images stored in a database 184 to determine whether there is a match 185. When a match is found between the acquired retina image and stored retina images contained in the template set, this prompts the linkage key 111 assigned to the identified enrolled customer to display the stored data 114, i.e., customer identification number, name, address, photograph, payment information, and the one or more preferences of one or more foods and/or drinks, on a display screen 108 of the one or more computing devices 106. When the retina image identification software 183 does not find a match between the acquired retina image with the template set of retina images stored in the database 184 after running a comparison 185, the display screen remains blank 108′.

Retinal identification involves the use of patterns of veins in the back of the eye to accomplish recognition. A retina scan, captured with a retinal scanning device, provides an analysis of the capillary blood vessels located in the back of the eye using a low-intensity light to take an image of the pattern formed by the blood vessels.

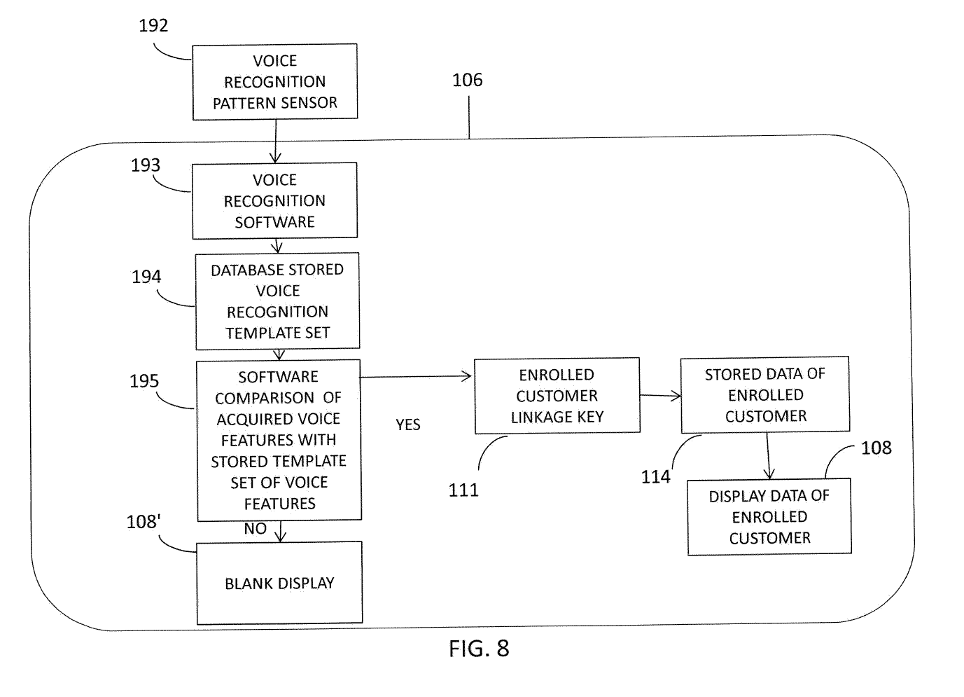

FIG. 8 shows the use of voice recognition for identifying an enrolled customer. A voice recognition pattern of an enrolled customer is inputted by an enrolled customer using a voice recognition acquisition sensor 192. Voice recognition software 193 compares the acquired voice pattern with a template set of voice patterns stored in a database 194 to determine whether there is a match 195. When a match is found between the acquired voice pattern and the stored voice patterns contained in the template set, this prompts the linkage key 111 assigned to the identified enrolled customer to display the stored data 114, i.e., customer identification number, name, address, photograph, payment information, and the one or more preferences of one or more foods and/or drinks, on a display screen 108 of the one or more computing devices 106. When the voice recognition software 193 does not find a match between the acquired voice pattern with the template set of voice patterns stored in the database 194 after running a comparison 195, the display screen remains blank 108′.

Voice recognition analyzes pitch, tone, cadence and frequency of a person's voice. A text-dependent voice recognition system is based on the utterance of a fixed predetermined phrase. A text-independent voice recognition system recognizes the speaker independent of what is spoken.

The text-dependent voice recognition system involves saying the same phrase for enrollment and verification. A voice recognition algorithm determines if a voice sample matches a template that was extracted from a specific phrase.

In accordance with the invention, during the enrollment process, one or more phrases are downloaded into a database of the one or more computing devices from the customer being enrolled, which one or more phrases then are spoken into a voice recognition acquisition system each time the enrolled customer enters the facility offering the enhanced service and hospitality program.

Alternatively, a customer may record a unique phrase such as passphrase or an answer to a “secret question” which is known only by the customer being enrolled. The customer later can then be recognized by his or her own specific phrase with a high degree of accuracy.

The text-dependent voice recognition system involves using different phrases for customer enrollment and recognition. This method is more convenient, as it does not require a customer to remember the passphrase. It may be combined with the text-dependent algorithm to perform faster text-independent search with further phrase verification using the more reliable text-dependent algorithm.

In addition, several voice records of the same phrase of a customer may be stored in a template database to improve voice recognition reliability. For example, natural voice variations, such as a hoarse voice, or indoor versus outdoor voice variations, may be stored in the same template of the database.

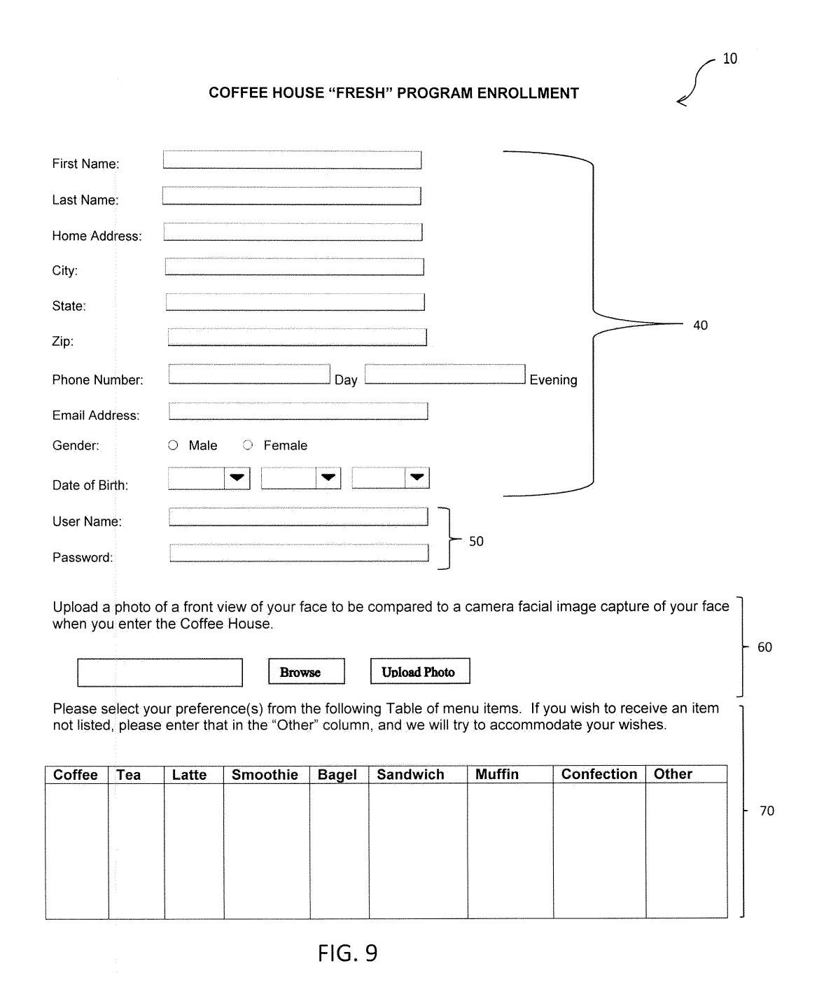

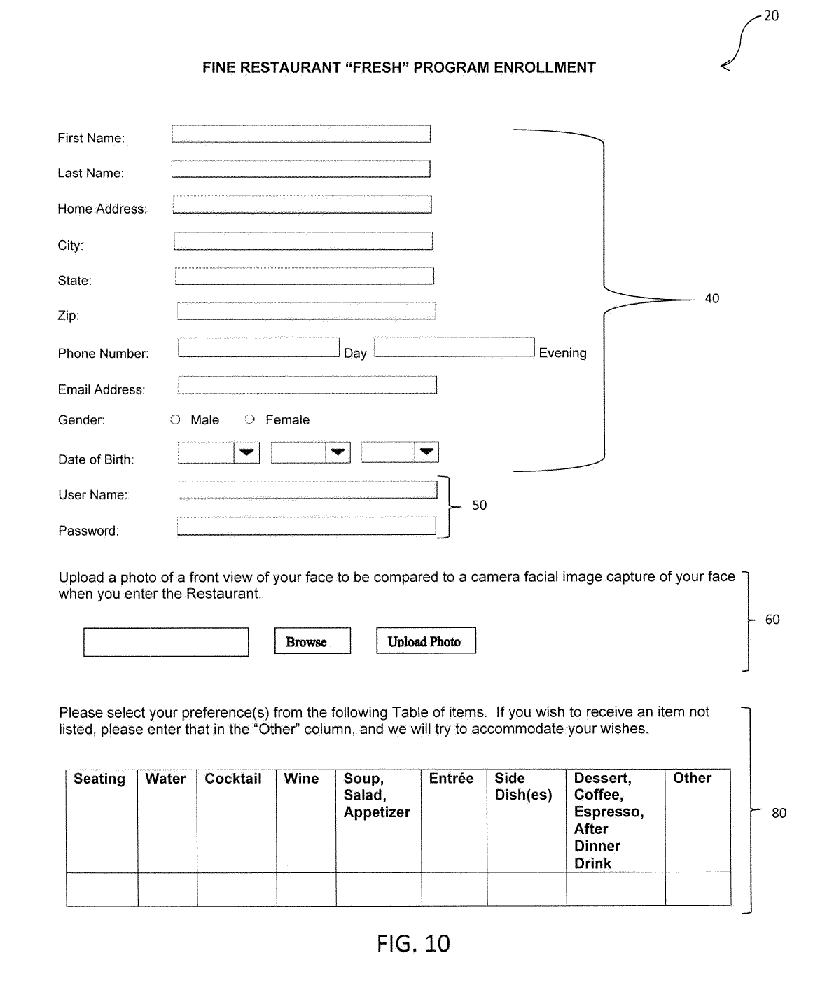

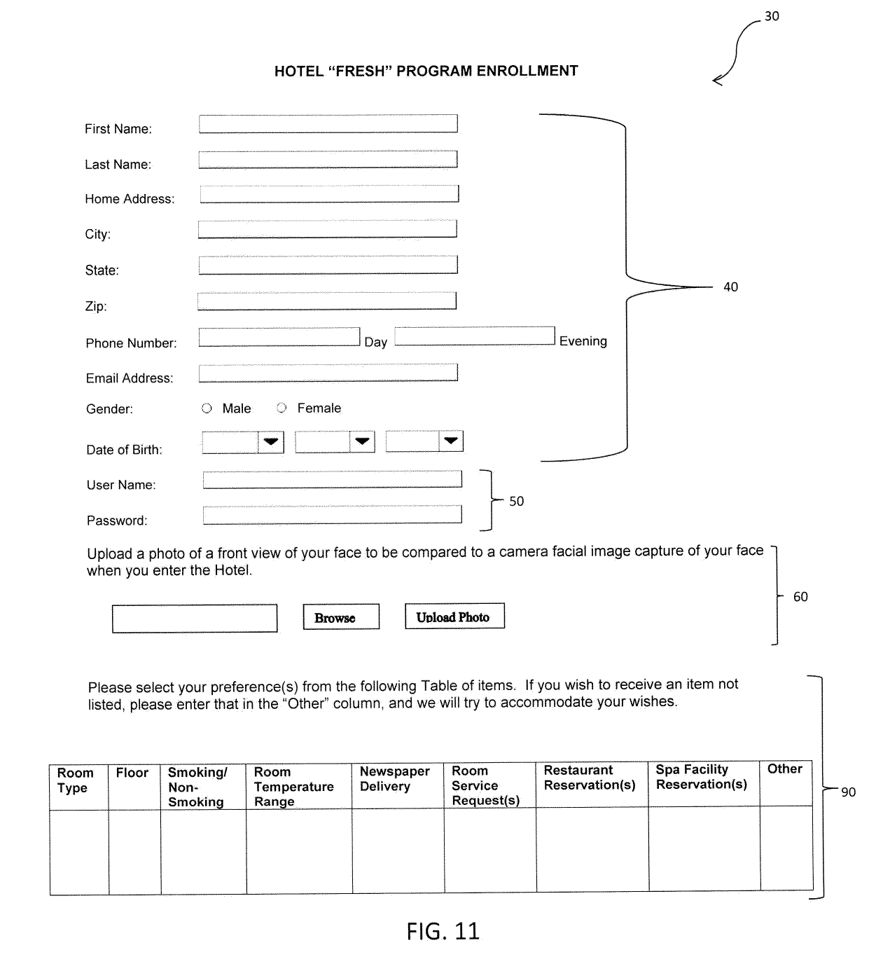

FIGS. 9-11 illustrate three exemplary, but non-limiting enrollment forms downloaded from websites of three different exemplary, but non-limiting, facilities offering the enhanced service and hospitality program of the invention: a coffee house 10 (FIG. 9), a fine restaurant 20 (FIG. 10) and a hotel 30 (FIG. 11). After downloading the enrollment form on a computing device, a customer is prompted to enter their name, address, day and evening phone number, email address, gender, and date of birth 40, pick a user name and password 50, and upload a recent photograph 60. The customer also is asked to provide one or more preferences in a Table listing service items of the facility 70, 80, 90. The enrollment form also prompts the customer to enter security, credit card and any other information required by the facility (not shown).

As shown in FIG. 9, the enrollment form of the coffee house 10 contains a Table 70 containing, for example, nine service items: Coffee, Tea, Latte, Smoothie, Bagel, Sandwich, Muffin, Confection and Other. A customer may provide, for example, the following preferences: under Coffee: milk and sugar; under Muffin: blueberry; and under Confection: 70% cocoa chocolate bar.

As shown in FIG. 10, the enrollment form of the fine restaurant 20 contains a Table 80 containing nine service items: Seating; Water, Cocktail; Wine; Soup, Salad and Appetizer; Entrée, Side Dish(es); Dessert, Coffee, Espresso, Capuccino, After Dinner Drink; and Other. A customer may provide, for example, the following preferences: under Seating: Table 3 near window; under Water: sparkling; under Wine: bottle house red wine; under Soup: French onion soup; under Coffee: capuccino; and under After Dinner Drink: brandy.

As shown in FIG. 11, the enrollment form of the hotel contains a Table 90 containing nine service items: Room Type, Floor, Smoking/Non-Smoking; Room Temperature Range; Newspaper Delivery; Room Service Request(s); Restaurant Reservation(s); Spa Facility Reservation(s) and Other. A customer may provide, for example, the following preferences: Under Room Type: suite with king size bed; under Floor: top floor: under Smoking/Non-Smoking: non-smoking; under Room Temperature Range: set at 75 degrees; under Newspaper Delivery: daily delivery local paper; under Room Service Request(s): breakfast (listing breakfast items) each morning at 9; under Other: wake-up call at 7 AM every morning.

In accordance with the invention, each facility providing the enhanced service and hospitality program of the invention will include their particular service items in the table, which is not limited to any particular number of service items and/or number of preferences a customer may provide related to those service items.

The invention contemplates that any service item in a Table of service items in which a customer has no particular preference will be left blank. The invention also contemplates that a customer will list one or more preferences which they wish to have fulfilled each time they go to a particular facility. The invention further contemplates that if an enrolled customer wants to change one or more of their preferences, these changes can be made by the enrolled customer going to the facility in person to request the changes, or by visiting the website of the facility, retrieving their enrollment form, and changing their preference(s) online.

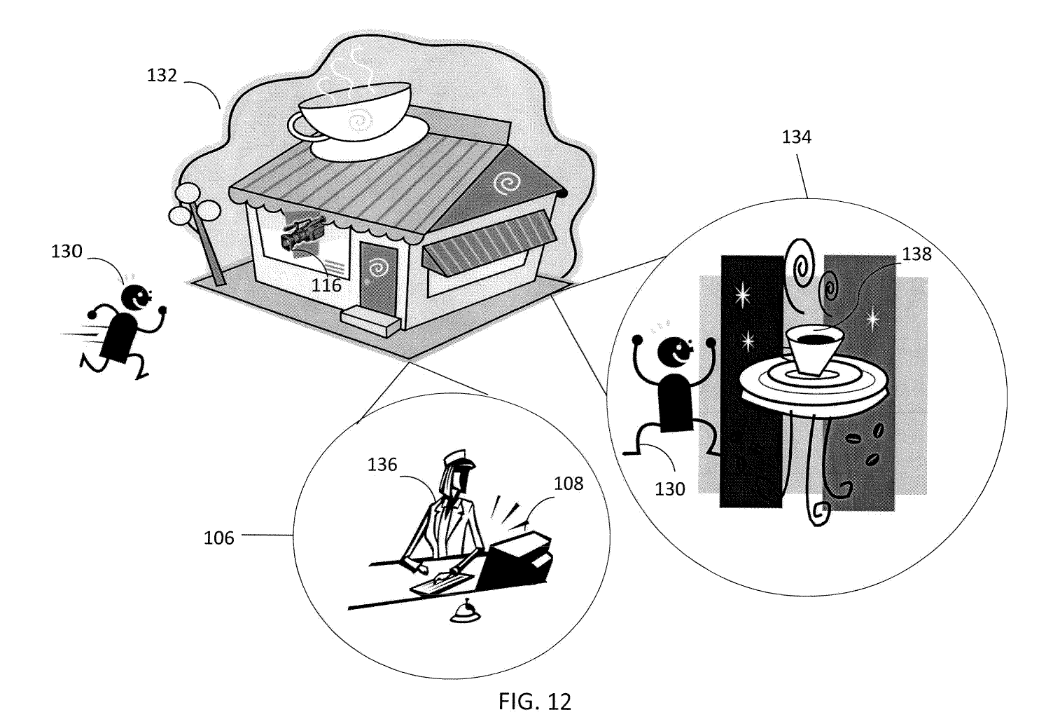

FIG. 12 illustrates a non-limiting embodiment of the systems and methods of the invention in operation related to the purchase of a morning coffee in a coffee house facility 132 using facial recognition software. A camera 116 located at or near the entrance of the coffee house 132 captures a facial image of an approaching enrolled customer 130. The facial image is sent from the camera 116 to a computing device of the facility 106. The computing device 106, comprising a microprocessor, facial recognition software and database software, and storing personal profiles, stored photographs, other stored information such as security and credit card information, stored faceprints, and one or more preferences for each enrolled customer, runs the facial recognition software to compare the facial image of the approaching customer 130 captured by the camera 116 with stored faceprints of enrolled customers to determine whether the facial image matches any of the stored faceprints. When a match is found between the facial image from the camera 116 and a stored faceprint, the PC linkage key assigned to that faceprint prompts the display of the photograph, the personal profile, the credit card and other information, the one or more preferences and the customer ID number of the enrolled customer on the display screen 108 of the computing device 106, which is viewed by a service provider 136. The service provider 136 proceeds to process the one or more preferences related to a particular service shown on the display screen, which when completed is sent to a enrolled customer designated area, referred to herein as the “enhanced service and hospitality” area 134. in accordance with the invention, it is contemplated that by the time the enrolled customer 130 arrives at the enhanced service and hospitality area 134, the preferred item(s) 138 of the enrolled customer 130 (i.e., coffee made according to the one or more preferences of the enrolled customer) is in preparation or already has been prepared and is waiting for the enrolled customer 130 at the enhanced service and hospitality area 134. The enrolled customer 130 then can pick up their preferred item(s) 138 and proceed to leave the facility 132 without ever speaking with a service provider 136 to place their order, without having to wait for any substantial length of time to place their order and/or to receive their preferred item(s) 138, and without the need to proffer payment for the preferred item(s) 138, as the preferred item(s) 138 is charged to the enrolled customer 130 using the credit card information stored in the database and displayed on the display screen 108 of the computing device 106 for that enrolled customer.

Biometrics refers to the quantifiable data (or metrics) related to human characteristics and traits. Biometric identifiers are the distinctive, measurable physiological and behavioral characteristics used to label and describe individuals. Biometric identification includes, for example, facial recognition, fingerprint identification, palm print identification, eye iris, retina recognition and voiceprint recognition. Thus, physiological characteristics which may be identified include, but are not limited to, fingerprint, face, DNA, palm print, palm veins, hand geometry, iris, retina, DNA and others.

A biometric identification system essentially is a pattern recognition system that operates by acquiring biometric data from an individual, extracting a feature set from the acquired data, and comparing this feature set against the template set in a database. Depending on the application context, a biometric system may operate either in verification mode or identification mode.

In the verification mode, the system validates a person's identity by comparing the captured biometric data with her own biometric template(s) stored in the system database.

In the identification mode, the system recognizes an individual by searching the templates of all the users in the database for a match. Therefore, the system conducts a one-to-many comparison to establish an individual's identity, or fails to establish an individual's identify if the person is not contained in the system database.

All biometric identification systems involves the use of software recognition engines run on a computing device along with algorithms to identify a particular individual based on a particular physiological characteristic, such as, for example, fingerprints, facial image, voice, iris, retina, or palm prints. The computing device accepts identification input from the particular biometric components, i.e., fingerprint, palm, face, voice iris, retinal or other biometrics, runs the particular identification algorithms based on the biometric input against template sets stored in the database of the computing device, and then returns identification results.

In accordance with the invention, the enrollment process involves capturing and storing biometric information from a customer. In subsequent uses, biometric information is detected and compared with the information stored at the time of enrollment. Biometric information is captured using an image acquisition sensor or other sensors depending on the biometric characteristics desired. All artifacts from the sensor are removed in order to enhance the input of biometric characteristics, such as background noise. All necessary features then are extracted. An image with particular properties then is used to create a template which is a synthesis of relevant biometric characteristics extracted from the sensor. The template is stored in a database of the one or more computing devices. During the matching, or identification phase, the captured template is relayed to a biometric matching or identification algorithm which compares it with the templates, or template set, stored in the database.

Any suitable biometric imaging acquisition system, biometric scanner, database management software and biometric identification software may be used in accordance with the systems and methods of the invention. Biometric imaging acquisition systems, biometric scanners, database management software and biometric identification software programs are well known by those skilled in the art, and those skilled in the art will have little difficulty deciding on which particular biometric imaging acquisition system, biometric scanner, database management software and biometric identification software programs to use in order to implement the systems and methods of the invention.

Suitable customer number dispenser devices, referred to as “take-a-number” devices, are well known by those skilled in the art and include, without limitation, hard wired and wireless push button devices. In accordance with the invention, a facility offering the enhanced service and hospitality program will connect, either wirelessly or by wired connection, a take-a-number device to the one or more computing devices. Software for using the take-a-number device is downloaded into the one or more computing devices in order to show non-enrolled customer activity in real time. All non-enrolled customer tickets are stored in the system with their date of service and begin order lead times which is viewed in real time on the one or more computing devices of the facility. The software therefore allows for daily, weekly or monthly statistical compilation of order transactions. Statistical information includes number of non-enrolled customers served and begin order lead times for the non-enrolled customers.

### Example

In operation, in accordance with the systems and methods of the invention, the following non-limiting example illustrates comparative order lead times of enrolled customers versus non-enrolled customers in the enhanced service and hospitality program of a restaurant using biometrics.

### 1. Rapid, Enhanced Service and Hospitality for Enrolled Customers Versus Conventional Service for Non-Enrolled Customers Using Facial Recognition Software

### A. Enrolled Customer

An enrolled customer enters a restaurant and goes directly to the designated enhanced service and hospitality pick-up area. A digital camera placed at the entrance of the restaurant captures a digital facial image of the enrolled customer as he/she enters the restaurant. The facial image is sent wirelessly via radio frequency to ten computers located inside the restaurant, in which five service providers each monitor two of the ten computers. Each of the ten computers is connected with each of the other computers as part of a local area network (LAN) of the restaurant. Facial recognition software in the computers compare the camera-captured facial image with database-stored faceprints to determine whether there is a match between the facial image and one of the stored faceprints. A match is found and a customer linkage key assigned to the matched, i.e., identified, customer links together the identified customer with his customer identification number, photograph, name, address, payment information, and the one or more food and/or drink preferences of the identified customer.

When service providers monitoring the computers see the display information, they click a “view” button on the screen, and the first service provider to click the “view” button causes the display screens of the other nine computers to close the display information for that enrolled customer, thus freeing the other nine computers to display information for other customers as they enter the restaurant. Upon clicking the “view” button, the order lead time for the enrolled customer begins, referred to as “begin order lead time,” which time is 11:45 AM. The computer also calculates the cost of the order and charges the order to the customer using the payment information stored in the computer.

The service provider viewing the information of the enrolled customer on their display screen then communicates via computer the one or more foods and/or drinks preferences to order preparers who receive the order via a computer, with one order preparer then proceeding to prepare the order. The food and/or drink preferences of the enrolled customer are a large iced tea and a muffin. Once prepared, the order preparer clicks an “end order lead time” button, which time is 11:47 AM, and a label is printed out by a printer connected to the computer used by the order preparer, which label shows the items prepared, their total cost, the name and customer identification number of the enrolled customer. The label is affixed to the enrolled customer's order and the order is delivered by a service provider to a designated enhanced service and hospitality pick-up area. The enrolled customer picks up his order and leaves the restaurant.

### B. Non-Enrolled Customer

A non-enrolled customer enters a restaurant and a digital camera placed at the entrance of the restaurant captures a digital facial image of the non-enrolled customer as he/she enters the restaurant. The facial image is sent wirelessly via radio frequency to ten computers located inside the restaurant, in which five service providers each monitor two of the ten computers. Facial recognition software in the computers compare the camera-captured facial image with database-stored faceprints to determine whether there is a match between the facial image and one of the stored faceprints. No match is found.

The customer proceeds into the restaurant and goes to a designated order area where orders are taken. In the order area, there is a take-a-number device. The customer takes a number and waits on line to place his/her order. When the customer takes a number, a customer order number and time is stamped on a piece of paper which is retrieved by the customer, which information also is relayed to ten computing devices monitored by five service providers. The display screens of the computer devices shows only a customer order number and the time of 11:45 AM, which time is the “begin time” for the non-enrolled customer. A service provider clicks on the customer order number, which causes the display screens of the other nine computers to close the display information for that customer, thus freeing the other nine computers to display information for other customers as they enter the restaurant. There are two people ahead of the customer in the order area, and the customer waits her turn to place her order of a large iced tea and a muffin with a service provider. When it is the non-enrolled customer's turn, she gives the service provider her order, the service provider calculates the cost of the order, asks the customer for payment, and the customer pays for the order, receiving a receipt for the order. The service provider then relays the order via a computer to an order preparer, who receives the order via a computer, which display screen shows only the order and the customer order number.

When the order preparer completes the order, they click the “end order lead time” button on their display screen of the computer, which time is 12:05 PM. The order preparer gives the order to a service provider, who delivers the order to a conventional designated pick-up area. The non-enrolled customer picks up his/her order from the pick-up area and leaves the restaurant.

The computers contain “order lead time” and “average order lead times” quantification algorithms in order to calculate order lead times for the enrolled customer and the non-enrolled customer, as well as to automatically and continuously calculate and update the average order lead times for all enrolled customers and non-enrolled customers. The order lead time for the enrolled customer is calculated as being eight times faster than the order lead time for the non-enrolled customer, which is inputted into the database for all enrolled customers and non-enrolled customers.

Calculation of the average order lead time for all enrolled customers compared with all non-enrolled customers in the restaurant is performed by a comparison algorithm for average order lead times on the ten computers. The average order lead time is defined as the sum of all of the order lead times for each group, i.e., enrolled customers and non-enrolled customers, divided by the number of customers in that group.

Prior to the enrolled customer and the non-enrolled customer order lead time entries into the computers, the previous average order lead time was calculated as being eight times faster for enrolled customers compared to non-enrolled customers. After entry of the enrolled and non-enrolled customers' order lead times, the average order lead time is updated by the computers to show an average order lead time for all enrolled customers that is nine times faster than the average order lead time for all non-enrolled customers. The computers also calculate the range of all average order lead time comparisons starting from a set date in the past to the present time, which range is shown to be five to ten times faster for all enrolled customers compared to non-enrolled customers patronizing the restaurant during that time frame.

While specific embodiments have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the system and method described herein, which is to be given the full breadth of the appended claims and any and all equivalents thereof.

1. (canceled)

2. The computer-implemented system of claim 19, wherein the biometric identifiers provided by an enrolled customer are stored in a template set in a database contained in database management software operated by at least one microprocessor, said at least one microprocessor controlling the one or more computing devices.

3. The computer-implemented system of claim 19, wherein the begin order lead time for a non-enrolled customer is the time when the non-enrolled customer takes a number displayed on a number dispenser device which releases a paper customer order number, said dispenser device relaying the customer order number and the begin order lead time to one or more computing devices, said customer order number and said begin order lead time stored in a database of the one or more computing devices, wherein the end order lead time is the time when the order is completed by an order preparer, said order preparer clicking an end order lead time button on the display screen for the non-enrolled customer.

4. The computer-implemented system of claim 19, wherein enrollment of a customer in the service and hospitality program comprises: (1) the customer providing the biometric identifiers and the data to facility, said biometric identifiers and data entered into the database of the one or more computing devices; (2) the one or more computing devices assigning the customer identification number to the customer; and (3) the one or more computing devices assigning an enrolled customer linkage key, wherein when an enrolled customer is identified by the biometric identification software, said linkage key retrieves the data of the enrolled customer and displays the data on the one or more computing devices.

5. The computer-implemented system of claim 19, wherein the biometric identifiers comprise facial recognition, fingerprint identification, palm print identification, iris recognition, retina recognition and voiceprint recognition.

6. The computer-implemented system of claim 5, wherein the biometric identifiers are identified with biometric identification software selected from facial recognition software, fingerprint identification software, palm print identification software, iris recognition software, retina recognition software and voiceprint recognition software.

7. The computer-implemented system of claim 19, wherein the execution of the biometric identification software program by the one or more computing devices comprises acquiring biometric data of a customer when the customer enters the facility, extracting a feature set from the acquired data, and comparing the feature set against a template set for each enrolled customer contained in the database in order to determine whether the customer is an enrolled customer.

8. The computer-implemented system of claim 19, wherein the one or more computing devices is selected from the group consisting of a desktop computer, a laptop computer, a tablet, a notebook, a smartphone and other computing devices having a display screen.

9. The computer-implemented system of claim 19, wherein the facility is selected from the group consisting of retail food and/or drink establishments, restaurants, hotels, motels, inns, lodges, bed and breakfasts, airports, cruise lines, amusement parks, and any other service-related facility providing recreational, travel and/or tourism-related services.

10. A computer-implemented method using biometrics for providing and Quantifying a rapid order lead time for a customer enrolled in an enhanced service and hospitality program offered by a facility compared to order lead time for a customer not enrolled in the program, the method comprising:
storing biometric identifiers provided by a customer enrolled in an enhanced service and hospitality program offered by a facility in a template set in a database contained in database management software, said database management software operated by at least one microprocessor, said at least one microprocessor controlling one or more computing devices;
storing data of the enrolled customer in the database, said data comprising a customer identification number, name, address, payment information, photograph, and one or more preferences of the customer for one or more foods and/or drinks sold by the facility;
executing a biometric identification software program to identify biometric identifiers of a customer by the one or more computing devices when the customer enters the facility, said biometric identifiers of the customer acquired by an image acquisition sensor, said acquired biometric identifiers relayed to the one or more computing devices which determines whether the customer entering the facility is an enrolled customer in the service and hospitality program offered by facility;
viewing the data of the customer on the display screen by a service provider when the one or more computing devices determines that the customer is an enrolled customer, said time of the viewing beginning order lead time for an order of one or more foods and/or drinks of the customer;
inputting time of viewing by the service provider by clicking a begin order lead time button on the display screen, wherein clicking the begin order lead time button begins order lead time for an order of the one or more foods and/or drinks preferred by the enrolled customer,
placing the order by one of the one or more service providers by relaying the order to one or more order preparers via one of the one or more computing devices;
preparing the order by the one or more order preparers;
clicking an end order lead time button on the display screen when the order is completed, wherein clicking the end order lead time button ends the order lead time for the order of the enrolled customer;
delivering the order after it is prepared by one or more service providers to a service and hospitality area of the facility for pick-up by the enrolled customer;
calculating by the one or more computing devices the order lead time of the enrolled customer, wherein said order lead time is equal to the difference between the begin order lead time and the end order time, wherein said order lead time is automatically inputted into a database by the one or more computing devices containing order lead times of all enrolled customers;
calculating by the one or more computing devices the order lead time for a customer not enrolled in the enhanced service and hospitality program after the begin order lead time and the end order lead time for the order has been relayed to a database of the one or more computing devices containing order lead times of all non-enrolled customers;
calculating the average order lead time for all enrolled customers and the average order lead time for all non-enrolled customers; and
quantifying the rapidity of the services to customers enrolled in the enhanced service and hospitality program offered by the facility compared to customers not enrolled in the program by the one or more computing devices by running a comparison algorithm which compares the average order lead time of all enrolled customers with the average lead time of all non-enrolled customers, said quantifying step providing a reliable and accurate way to gauge the efficiency and effectiveness of the services offered by the facility.

11. The computer-implemented method of claim 10, wherein the biometric identifiers provided by an enrolled customer are stored in a template set in a database contained in database management software operated by at least one microprocessor, said at least one microprocessor controlling the one or more computing devices.

12. The computer-implemented method of claim 10, wherein the begin order lead time for a non-enrolled customer is the time when the non-enrolled customer takes a number from a number dispenser device, said dispenser device relaying the customer order number and the begin order lead time to one or more computing devices, said customer order number and said begin order lead time stored in a database of the one or more computing devices, wherein the end order lead time is the time when the order is completed by an order preparer, said order preparer clicking an end order lead time button on the display screen for the non-enrolled customer.

13. The computer-implemented method of claim 10, wherein enrollment of a customer in the service and hospitality program comprises: (1) the customer providing the biometric identifiers and the data to facility, said biometric identifiers and data entered into the database of the one or more computing devices; (2) the one or more computing devices assigning the customer identification number to the customer; and (3) the one or more computing devices assigning an enrolled customer linkage key, wherein when an enrolled customer is identified by the biometric identification software, said linkage key retrieves the data of the enrolled customer and displays the data on the one or more computing devices.

14. The computer-implemented method of claim 10, wherein the biometric identifiers comprise facial recognition, fingerprint identification, palm print identification, iris recognition, retina recognition and voiceprint recognition.

15. The computer-implemented method of claim 14, wherein the biometric identifiers are identified with biometric identification software selected from facial recognition software, fingerprint identification software, palm print identification software, iris recognition software, retina recognition software and voiceprint recognition software.

16. The computer-implemented method of claim 10, wherein the execution of the biometric identification software program by the one or more computing devices comprises acquiring biometric data of a customer when the customer enters the facility, extracting a feature set from the acquired data, and comparing the feature set against a template set for each enrolled customer contained in the database in order to determine whether the customer is an enrolled customer.

17. The computer-implemented method of claim 10, wherein the one or more computing devices is selected from the group consisting of a desktop computer, a laptop computer, a tablet, a notebook, a smartphone and other computing devices having a display screen.

18. The computer-implemented method of claim 10, wherein the facility is selected from the group consisting of retail food and/or drink establishments, restaurants, hotels, motels, inns, lodges, bed and breakfasts, airports, cruise lines, amusement parks, and any other service-related facility providing recreational, travel and/or tourism-related services.

19. A computer implemented system using biometrics for providing and quantifying a rapid order lead time for a customer enrolled in an enhanced service and hospitality program offered by a facility compared to order lead time of a customer not enrolled in the program, comprising:
an image acquisition sensor which acquires biometric identifiers of a customer when the customer enters a facility;
one or more computing devices which executes a biometric identification software program to identify the customer and to determine whether the customer is an enrolled customer in a service and hospitality program offered by the facility, said determination accomplished by executing a search of a database contained in the one or more computing devices, said database containing biometric identifiers and data of enrolled customers in the service and hospitality program;
a display screen that displays the data of the customer when the one or more computing devices determines that the customer is an enrolled customer;
transmission of the data from one of the one or more computing devices to another one of the one or more computing devices when a begin order lead time button is clicked on the display screen;
calculation of order lead time of the enrolled customer by the one or more computing devices when an end order lead time button is clicked on the display screen, said order lead time equal to the difference between the begin order lead time and the end order time;
calculation by the one or more computing devices of order lead time of a non-enrolled customer;
input of the order lead time of the non-enrolled customer into a database containing order lead times for all non-enrolled customers;
calculation by the one or more computing devices of average order lead time of all non-enrolled customers contained in the database; and
quantification of the rapidity of the services to customers enrolled in the enhanced service and hospitality program offered by the facility compared to customers not enrolled in the program by the one or more computing devices by running a comparison algorithm which compares the average order lead time of all enrolled customers with the average lead time of all non-enrolled customers, wherein said quantification provides a reliable and accurate way to gauge the efficiency and effectiveness of the services offered by the facility.

20. The computer-implemented system of claim 19, wherein the data comprises a customer identification number assigned to the enrolled customer, name, address, payment information, photograph, and one or more preferences of the customer for one or more foods and/or drinks sold by the facility.
